(19) United States
(12) Patent Application Publication
(10) Pub. No.: US 2021/0224821 A1
(43) Pub. Date: Jul. 22, 2021

(54) LAND USAGE PROPERTY IDENTIFICATION METHOD, APPARATUS, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Xinjiang Lu, Beijing (CN); Shangfo Huang, Beijing (CN); Hui XIONG, Beijing (CN)

(73) Assignee: BEIJING BAIDU NETCOM SCIENCE AND TECHNOLOGY CO., LTD., Beijing (CN)

(21) Appl. No.: 17/208,671

(22) Filed: Mar. 22, 2021

(30) Foreign Application Priority Data
Jul. 24, 2020 (CN) 202010728273.3

(51) Int. Cl. G06Q 30/00; G06K 9/62; G06Q 30/02; G06Q 50/26; G06N 20/00; G06N 5/04

(52) U.S. Cl. CPC G06Q 30/018; G06K 9/6298; G06K 9/6267; G06Q 30/0201; G06K 9/00651; G06Q 50/26; G06N 20/00; G06N 5/04; G06Q 30/0205

(57) ABSTRACT

A land usage property identification method, apparatus, electronic device and storage medium are disclosed. The method includes: acquiring point-of-interest (POI) data and area-of-interest (AOI) data; dividing a target area to be identified according to road network information, and obtaining at least one block in the target area; associating acquired POI data to a corresponding target block in the at least one block; obtaining a first weight set corresponding to a corresponding category of each POI data in the target block; obtaining a second weight set corresponding to a corresponding area of each AOI data in the target block; obtaining a land usage property weight set according to the first weight set, the second weight set and a preset land usage classification standard; and identifying a land usage property of the target block according to a target weight in the land usage property weight set.

### CROSS-REFERENCE TO RELATED APPLICATION

This application claims priority to Chinese Patent Application No. 202010728273.3, filed on Jul. 24, 2020, which is hereby incorporated by reference in its entirety.

### TECHNICAL FIELD

The present application relates to the field of information processing. The present application particularly relates to the fields of artificial intelligence, big data and map technology, and may be applied to the fields such as identification and identification comparison related to land usage properties and displaying land usage properties.

### BACKGROUND

Classification of urban land usage properties provides an important reference basis for urban planning, so that urban managers can allocate urban resources scientifically and reasonably and lay a foundation for urban development.

### SUMMARY

The present application provides a land usage property identification method, an apparatus, an electronic device and a storage medium.

According to an aspect of the present application, a land usage property identification method is provided and includes:

acquiring point-of-interest (POI) data and area-of-interest (AO) data;

dividing a target area to be identified according to road network information, and obtaining at least one block in the target area;

associating acquired POI data to a corresponding target block in the at least one block;

in response to weight processing of the POI data, obtaining a first weight set corresponding to a corresponding category of each POI data in the target block;

in response to weight processing of the AOI data, obtaining a second weight set corresponding to a corresponding area of each AOI data in the target block;

obtaining a land usage property weight set according to the first weight set, the second weight set and a preset land usage classification standard; and

identifying a land usage property of the target block according to a target weight in the land usage property weight set, wherein a weight value of the target weight is greater than all other weights in the land usage property weight set.

According to another aspect of the present application, a land usage property identification apparatus is provided and includes:

a data acquiring module configured for acquiring point-of-interest (POI) data and area-of-interest (AOI) data:

a block division module configured for dividing a target area to be identified according to road network information, and obtaining at least one block in the target area;

a data association module configured for associating the acquired POI data to a corresponding target block in the at least one block;

a first response module configured for, in response to weight processing of the POI data, obtaining a first weight set corresponding to a corresponding category of each POI data in the target block;

a second response module configured for, in response to weight processing of the AOI data, obtaining a second weight set corresponding to a corresponding area of each AOI data in the target block;

a processing module configured for obtaining a land usage property weight set according to the first weight set, the second weight set and a preset land usage classification standard; and

an identification module configured for identifying a land usage property of the target block according to a target weight in the land usage property weight set, wherein a weight value of the target weight is greater than all other weights in the land usage property weight set.

According to another aspect of the present application, an electronic device is provided and includes:

at least one processor; and

a memory communicatively connected to the at least one processor; wherein,

the memory stores instructions executable by the at least one processor to enable the at least one processor to implement the method provided in any embodiment of the present application.

According to another aspect of the present application, a non-transitory computer-readable storage medium storing computer instructions for causing a computer to perform the method provided in any embodiment of the present application.

It is to be understood that the contents in this section are not intended to identify the key or critical features of the embodiments of the present application, and are not intended to limit the scope of the present application. Other features of the present application will become readily apparent from the following description.

### BRIEF DESCRIPTION OF THE DRAWINGS

The drawings are included to provide a better understanding of the present application and are not to be construed as limiting the present application, in which.

FIG. 1 is a schematic diagram of a data interaction hardware entity of POI data and AOI data applied to an embodiment of the present application;

FIG. 2 is a schematic flowchart of a land usage property identification method according to an embodiment of the present application;

FIG. 3 is a schematic flowchart of a land usage property identification method according to an embodiment of the present application:

FIG. 4 is schematic flowchart of calculating area weights according to an application example of an embodiment of the present application;

FIG. 5 is a schematic flowchart of a land usage property identification method according to an application example of an embodiment of the present application;

FIG. 6 is a schematic diagram showing comparison of identification accuracy rates according to an application example of an embodiment of the present application;

FIG. 7 is a schematic diagram showing structures of a land usage property identification apparatus according to an embodiment of the present application; and

FIG. 8 is a block diagram of an electronic device used to implement a land usage property identification method according to an embodiment of the present application.

### DETAILED DESCRIPTION

Reference will now be made in detail to the exemplary embodiments of the present application, examples of which are illustrated in the accompanying drawings, where the various details of the embodiments of the present application are included to facilitate understanding and are to be considered as exemplary only. Accordingly, those skilled in the art should appreciate that various changes and modifications can be made to the embodiments described herein without departing from the scope and spirit of the present application. Also, descriptions of well-known functions and structures are omitted from the following description for clarity and conciseness.

The term “and/or” herein is only an association relationship that describes associated objects, which means that there may be three relationships, for example, A and/or B, may mean three situations including that only A exists, A and B exist at the same time, and only B exists. The term “at least one” herein means any one or any combination of at least two of the multiple, for example, including at least one of A, B, C, may mean including any one or more elements randomly selected from a set composed of A, B, and C. The terms “first” and “second” herein refer to a plurality of similar technical terms and distinguish them, and do not limit orders or limit only two, for example, a first feature and a second feature means that there are two types/two features, there may be one or more first features, and there may be one or more second features.

In addition, in order to better explain the present application, numerous specific details are given in the following specific embodiments. Those skilled in the art should understand that the present application may also be implemented without some specific details. In some examples, methods, means, elements and circuits well known to those skilled in the art have not been described in detail in order to highlight the main point of the present application.

In an early development of a city, distribution of urban land is relatively concentrated and simple. However, with the development of the city, distribution of urban land becomes more fragmented and complicated, and land usage properties in the same area would also change over time. Thus, a more fine-grained land usage property identification scheme is needed. In this regard, there is no effective solution in related art.

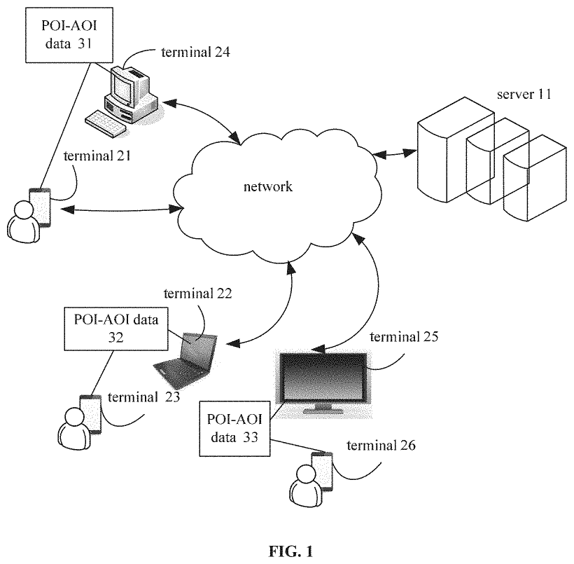

FIG. 1 is a schematic diagram of a data interaction hardware entity of POI data and AOI data applied to an embodiment of the present application. FIG. 1 shows: a server 11 (for example, one server or a server cluster composed of multiple servers), various terminals (including terminals 21-26) such as desktops, PCs, mobile phones, all-in-ones, etc., and POI-AOI data 31-33 interacting between various hardware entities. The various terminals may perform data exchange of POI data and AOI data with the server 11 through a wired network or a wireless network.

The POI data and AOI data may be collected based on the terminal or may be downloaded from the server. The POI data, the AOI data and blocks obtained based on road network information may be fused for accurately identifying land usage properties of the blocks.

The foregoing example in FIG. 1 is only an example of a system architecture for implementing the embodiment of the present application, and the embodiment of the present application is not limited to the foregoing system architecture shown in FIG. 1. Based on this system architecture, various embodiments of the present application are provided.

Introduction of several technical names mentioned in this disclosure are first described as follows:

1) POI data: it represents physical entities with geographic position information that actually exist in the city, such as shops, schools, residential areas, hospitals; one POI should have basic attributes such as geographic coordinate information, category information, name and position.

2) AOI data: it is also referred as POI area data, and it refers to points of interest with geometrical boundary information; in addition to all the basic attributes of the POI data, the AOI data further include geometrical boundary information to indicate a coverage of one AOL such as residential areas, schools, scenic spots.

3) POI with parent-child relationship: there may be parent-child relationship between POI data; for example, a parking lot of a science park is a child POI of the science park. One parent POI may contain multiple child POIs, and one POI belongs to at most one parent POI.

4) Block: it refers to a polygonal area surrounded by road segments obtained by dividing a city area based on the road network information and may be represented by Block.

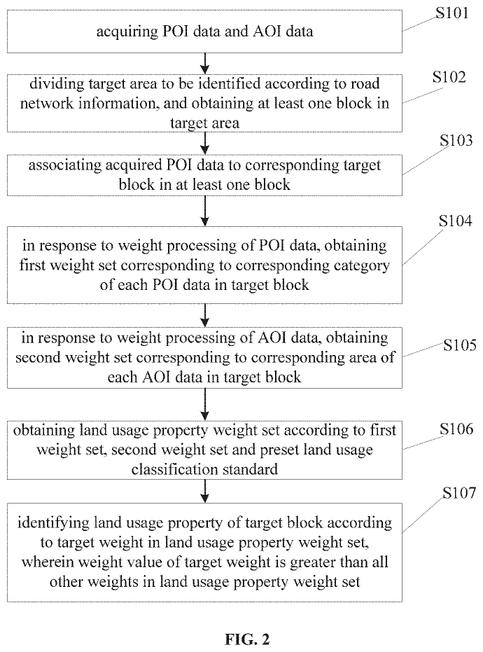

According to one embodiment of the present application, a land usage property identification method is provided. FIG. 2 is a schematic flowchart of a land usage property identification method according to an embodiment of the present application. The method may be applied to a land usage property identification apparatus, for example, the device may be deployed in a terminal or server or other processing equipment to perform various processing related to identification of land usage property. The terminal may be a user equipment (UE), a mobile device, a cellular phone, a cordless phone, a personal digital assistant (PDA), a handheld device, a computing device, a vehicle-mounted device, a wearable device, etc. In some possible implementations, the method may also be implemented in a manner in which a processor calls computer-readable instructions stored in a memory. As shown in FIG. 2, the method includes:

S101. acquiring POI data and AOI data.

In one example, the POI data may be a house, a shop, a community entrance or a bus station, etc.: the AOI data may include a residential community, a university, an office building, an industrial park, a comprehensive shopping mall, a hospital, a scenic spot or a gymnasium, etc. Compared with the POI, the AOI has better expressive power and more regional representation, as well as better stability. Compared with the rapid changes in positions of the POI, a frequency of changes in geographical entities expressed by the AOI will be much lower. It can be seen that the POI data and the AOI data are combined to consider subsequent land usage property identification, which ensures reliability of data, thereby improving an accuracy of land usage property identification.

S102: dividing a target area to be identified according to road network information, and obtaining at least one block in the target area.

In one example, an urban area (for example, a whole city such as Beijing, each administrative district such as Beijing Dongcheng District and Beijing Xicheng District, or, a common area other than an administrative district, such as Houhai or Sanlitun in Beijing) may be divided based on the road network information (such as network information of roads), thereby obtaining polygonal areas each surrounded by road segments in the urban area. The polygonal area is referred to as a block.

S103. associating acquired POI data to a corresponding target block in the at least one block.

In one example, POI coordinates corresponding to the POI data may be acquired, and the POI data may be associated with the target block based on the POI coordinates, thereby classifying the POI data to the target block.

S104: in response to weight processing of the POI data, obtaining a first weight set corresponding to a corresponding category of each POI data in the target block.

In one example, a category of each target POI in the first data set may be acquired based on a first data set composed of POI data. Statistical processing is performed on the category of each target POI, thereby obtaining at least one frequency parameter used for first weight calculation. The first weight set may be obtained according to the at least one frequency parameter.

S105: in response to weight processing of the AOI data, obtaining a second weight set corresponding to a corresponding area of each AOI data in the target block.

In one example, an area proportion corresponding to each AOI data may be obtained based on the AOI data, and a target area proportion is selected from area proportions, and the second weight set is obtained according to the target area proportion.

S106: obtaining a land usage property weight set according to the first weight set, the second weight set and a preset land usage classification standard.

S107: identifying a land usage property of the target block according to a target weight in the land usage property weight set, wherein a weight value of the target weight is greater than all other weights in the land usage property weight set.

In one example, for S106-S107, the land usage classification standard may be a given urban land usage classification standard (such as the national standard GB-50137-2018). Since the urban land usage classification standard may be associated with the category information of the POI data (i.e., the foregoing category of each target PO), then, according to the first weight set and the second weight set, a most representative weight of land usage property may be obtained, i.e., the target weight (the target weight may be the maximum weight) with a weight value being greater than all other weights in the land usage property weight set. The land usage property of the target block can be identified according to the maximum weight in combination with the urban land usage classification standard.

With the present application, the POI data and the AOI data may be acquired, the target area to be identified is divided according to the road network information, and at least one block in the target area is obtained. After the acquired PO data is associated to a corresponding target block in the at least one block, the first weight set corresponding to the corresponding category of each POI data in the target block is obtained, and the second weight set corresponding to the corresponding area of each AOI data in the target block is obtained. Then, the land usage property weight set is obtained according to the first weight set, the second weight set and the preset land usage classification standard. And then, the land usage property of the target block can be identified according to the target weight with its weight value being greater than all other weights in the land usage property weight set, thereby improving accuracy of land usage property identification.

Comparison between the present application and the related art is as follows. In the related art, the land usage property identification usually requires professional surveying and mapping personnel to carry out on-site investigation and research, which not only takes up a lot of labor costs, but also has low identification efficiency. Further, an area that can be identified is limited, and the identification process is difficult to be refined and updated in time. While in the present application, by fusing the POI data, the blocks obtained based on the road network information and the AOI data, a finer-grained distribution of land usage properties can be identified as compared to a block-level of the related art, thereby obtaining land usage properties of the blocks without the help of manual labor, and achieving automatic land usage identification through processing logic of foregoing S101-S107.

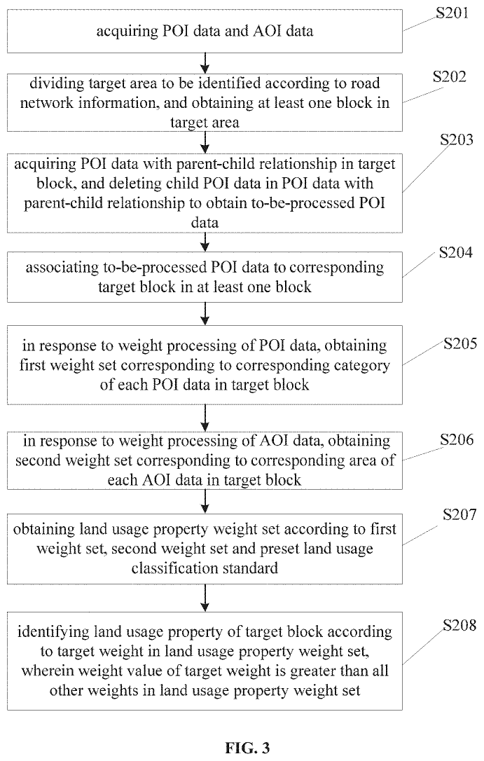

According to one embodiment of the present application, a land usage property identification method is provided. FIG. 3 is a schematic flowchart of a land usage property identification method according to an embodiment of the present application. As shown in FIG. 3, the method includes.

S201. acquiring POI data and AOI data.

In one example, the POI data may be a house, a shop, a community entrance or a bus station, etc.; the AOI data may include a residential community, a university, an office building, an industrial park, a comprehensive shopping mall, and a hospital, a scenic spot or a gymnasium, etc. Compared with the POI, the AOI has better expressive power and more regional representation, as well as better stability. Compared with the rapid changes in positions of the POI, a frequency of changes in geographical entities expressed by the AOI will be much lower. It can be seen that the POI data and the AOI data are combined to consider subsequent land usage property identification, which ensures reliability of data, thereby improving an accuracy of land usage property identification.

S202: dividing a target area to be identified according to road network information, and obtaining at least one block in the target area.

In one example, an urban area (for example, a whole city such as Beijing, each administrative district such as Beijing Dongcheng District and Beijing Xicheng District, or, a common area other than an administrative district, such as Houhai or Sanlitun in Beijing) may be divided based on the road network information (such as network information of roads), thereby obtaining polygonal areas each surrounded by road segments in the urban area. The polygonal area is referred to as a block.

S203: acquiring POI data with parent-child relationship in the target block, and deleting child POI data in the POI data with parent-child relationship to obtain to-be-processed POI data.

S204. associating the to-be-processed POI data to a corresponding target block in the at least one block.

In one example, POI coordinates corresponding to the to-be-processed POI data may be acquired, and the to-be-processed POI data may be associated with the target block based on the POI coordinates, thereby classifying the to-be-processed POI data to the target block.

S205: in response to weight processing of the POI data, obtaining a first weight set corresponding to a corresponding category of each POI data in the target block.

In one example, a category of each target POI in the first data set may be acquired based on a first data set composed of POI data. Statistical processing is performed on the category of each target POI, thereby obtaining at least one frequency parameter used for first weight calculation. The first weight set may be obtained according to the at least one frequency parameter.

S206: in response to weight processing of the AOI data, obtaining a second weight set corresponding to a corresponding area of each AOI data in the target block.

In one example, an area proportion corresponding to each AOI data may be obtained based on the AOI data, and a target area proportion is selected from area proportions, and the second weight set is obtained according to the target area proportion.

S207: obtaining a land usage property weight set according to the first weight set, the second weight set and a preset land usage classification standard.

S208: identifying a land usage property of the target block according to a target weight in the land usage property weight set, wherein a weight value of the target weight is greater than all other weights in the land usage property weight set.

In one example, for S207-S208, the land usage classification standard may be a given urban land usage classification standard (such as the national standard GB-50137-2018). Since the urban land usage classification standard may be associated with the category information of the POI data (i.e., the foregoing category of each target POI), then, a most representative weight of land usage property may be obtained according to the first weight set and the second weight set, i.e., the target weight (the target weight may be the maximum weight) with a weight value being greater than all other weights in the land usage property weight set. The land usage property of the target block can be identified according to the maximum weight in combination with the urban land usage classification standard.

With the present application, the POI data and the AOI data may be acquired, the target area to be identified is divided according to the road network information, and at least one block in the target area is obtained. POI data with parent-child relationship may be acquired in the target block, and child POI data in the POI data with parent-child relationship is deleted to obtain to-be-processed POI data, thereby reducing unnecessary child POIs without representative of the land usage property while retaining necessary parent POIs with representative of the land usage property, which will not reduce accuracy of identification but also improve processing efficiency of identification. Further, after the acquired POI data is associated to a corresponding target block in the at least one block, the first weight set corresponding to the corresponding category of each POI data in the target block is obtained, and the second weight set corresponding to the corresponding area of each AOI data in the target block is obtained. Then, the land usage property weight set is obtained according to the first weight set, the second weight set and the preset land usage classification standard. And then, the land usage property of the target block can be identified according to the target weight with its weight value being greater than all other weights in the land usage property weight set, thereby improving accuracy of land usage property identification.

In one embodiment, in response to weight processing of the POI data, obtaining a first weight set corresponding to a corresponding category of each POI data in the target block, includes: taking all acquired POI data as a first data set; for each target POI in the first data set, acquiring a category of the target POI, wherein all categories of POIs appearing in all the POI data constitute a second data set for representing POI categories; performing statistical processing on the category of each target POI in the second data set to obtain a first frequency parameter and a second frequency parameter; performing a weighting operation according to the first frequency parameter and the second frequency parameter to obtain the first weight set.

The performing statistical processing on the category of each target POI in the second data set to obtain a first frequency parameter and a second frequency parameter, includes: counting a frequency (such as the number of times) of the category of the target POI appearing in the target block to obtain the first frequency parameter (such as term frequency parameter), and counting the number of blocks corresponding to the category of the target POI appearing in block-level data in each administrative level area (i.e., the whole city, or other designated administrative levels, such as provinces, districts/counties), and obtaining the second frequency parameter (such as inverse document frequency index) according to the number of blocks.

In one example, the acquired POI data is recorded as a set P, a category of each target POI in the set P is acquired. All categories of POIs appearing in the POI data constitute a POI category set. For the category of each target POI in the POI category set, a frequency of the category of the target POI appearing in the target block is counted to obtain a first frequency parameter. The number of blocks corresponding to the category of the target POI appearing in block-level data in each administrative level area is counted, and the second frequency parameter is obtained according to the number of blocks. A weighting operation is performed according to the first frequency parameter and the second frequency parameter to obtain the first weight set.

In one embodiment, in response to weight processing of the AOI data, obtaining a second weight set corresponding to a corresponding area of each AOI data in the target block, includes: selecting a target area proportion from acquired proportions of the area corresponding to each AOI data, wherein the target area proportion is an area proportion, which is greater than all other area proportions in the target block and which represents land usage property, that is, the target area proportion is an area proportion representing a largest land use property: when the target area proportion meets a proportion threshold, obtaining the second weight set according to the target area proportion.

In one embodiment, the method further includes: acquiring a remaining land in the target block except for the area corresponding to each AOI data performing proportion calculation on the remaining land to obtain an area proportion of the remaining land: obtaining a remaining land property-average proportion according to the area proportion of the remaining land and the number of properties of the remaining land; adjusting the second weight set to obtain an adjusted second target weight set according to the remaining land property-average proportion. In this embodiment, in addition to considering the proportion of the area corresponding to the AOI data, the remaining land is also considered, so that in combination with the area weight obtained based on the AOI, a more accurate identification of the land usage properties of the block can be obtained.

### Application Example

Processing procedures of an application of one embodiment of the present application include the following contents.

First. Inputting the following three types of data.

1. POI data: it represents physical entities with geographic position information that actually exist in the city, such as shops, schools, residential areas, hospitals; one POI should have basic attributes such as geographic coordinate information, category information, name and position.

2. AOI data: it refers to POI with geometrical boundary information; in addition to all the basic attributes of the POI, the AOI data further include geometrical boundary information to indicate a coverage of one AOI, such as residential areas, schools, scenic spots.

3. POI with parent-child relationship: there may be parent-child relationship between POI data; for example, a parking lot of a science park is a child POI of the science park.

Second. Data preprocessing.

1. Fine-grained area division: dividing urban areas based on road network information, thereby obtaining polygonal areas surrounded by road segments, that is, blocks.

2. Creating a mapping table from POI category information to land usage properties according to a given urban land usage classification standard (such as the national standard GB-50137-2018) and POI category information. An example of the mapping table is as follows:

{‘real estate: residential area’: ‘residential land’,

‘real estate; office building’: ‘commercial land’}.

3. Associating blocks with the POIs according to POI coordinates, that is, a known POI set is classified to different blocks according to the POI coordinates.

4. In a given block, in a case that one POI only appears as a child POI according to the POI parent-child relationship, deleting the one POI.

Third. Calculating a topic distribution of the block based on a set of POIs associated with the block.

All POIs in the block may be regarded as a document, the category (tag) of the POI is taken as a word in the document, and a weight of a tag of each POI included in the block is calculated by using the term frequency-inverse document frequency (TF-IDF) algorithm.

The following TF-IDF operations may be performed according to the tag of a specified POI, and are divided into the following sub-contents:

1. Term frequency (TF): counting the number of times the tag of a given POI tag appears in the block.

2. Inverse document frequency Index (IDF): calculating the number of blocks that the tag of the given POI appears in the city (other administrative levels may also be specified, such as province, district/county, etc.), recording it as DF and taking its reciprocal as IDF.

3. Multiplying TF and IDF to get a TF-IDF weight of the tag of the given POI.

4. For a given block, calculating area weights of different tags of POIs within the block by using AOI data.

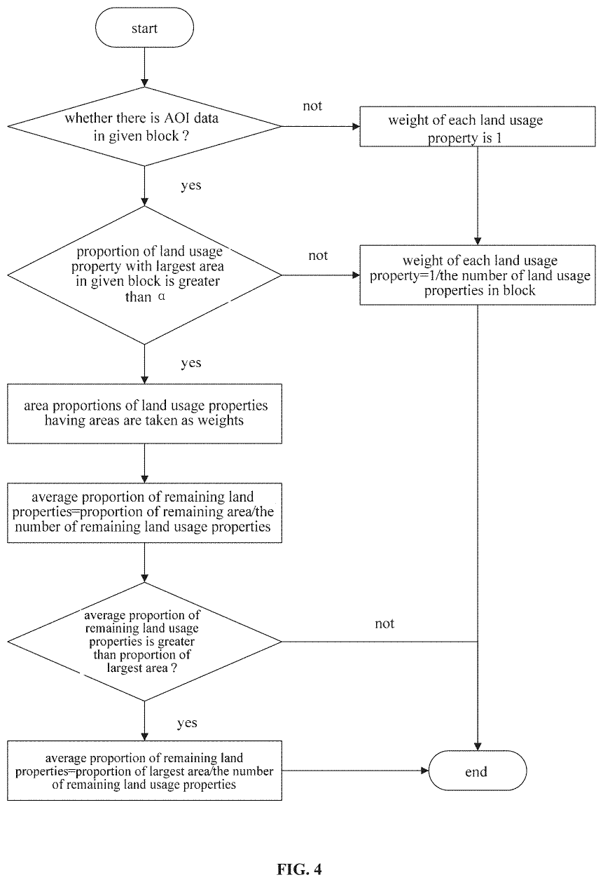

FIG. 4 is schematic flowchart of calculating area weights according to an application example of an embodiment of the present application. As shown in FIG. 4, whether there is AOI data in a given block is judged. If not, an area weight of each land usage property is set to be 1. If yes, it is continued to determine whether a proportion of a land usage property with the largest area in a given block is greater than a proportion threshold (a).

When determining whether the proportion of the land use property with the largest area in the given block area is greater than a, if not, an area weight of each land usage property is calculated with a calculation formula as follows: the area weight of each land usage property=1/the number of land usage properties in the block; if yes, area proportions of land usage properties having areas are taken as the area weights (the area weights constitute the second weight set in the foregoing embodiment of the present application), and an average proportion of the remaining land properties is calculated with a calculation formula as follows: average proportion of the remaining land properties=an proportion of remaining area/the number of remaining land usage properties.

It is continued to determine whether the average proportion of the remaining land usage properties is greater than a proportion of the largest area. If yes, the foregoing average proportion of the remaining land properties is updated with a calculation formula as follows: updated average proportion of the remaining land properties=the proportion of the largest area in the remaining area/the number of remaining land usage properties. In other words, calculation of the proportion of the remaining land is introduced to obtain the area proportion of the remaining land, which is adjusted in combination with the foregoing area weights to form the adjusted second target weight set in the foregoing embodiment of the present application. If not, the process of the current area weight is ended.

5. TF-IDF weight and area weight for the tag of each POI in a given block are calculated, and the two are multiplied to get weights of the tag of each POI in the given block. By looking up the mapping table from POI category information to land usage properties, the weight calculated for the tag of each POI is used as the weight of a corresponding land usage property. Meanwhile, the land usage property with the largest weight in the block is taken as the representative land usage property of a given block.

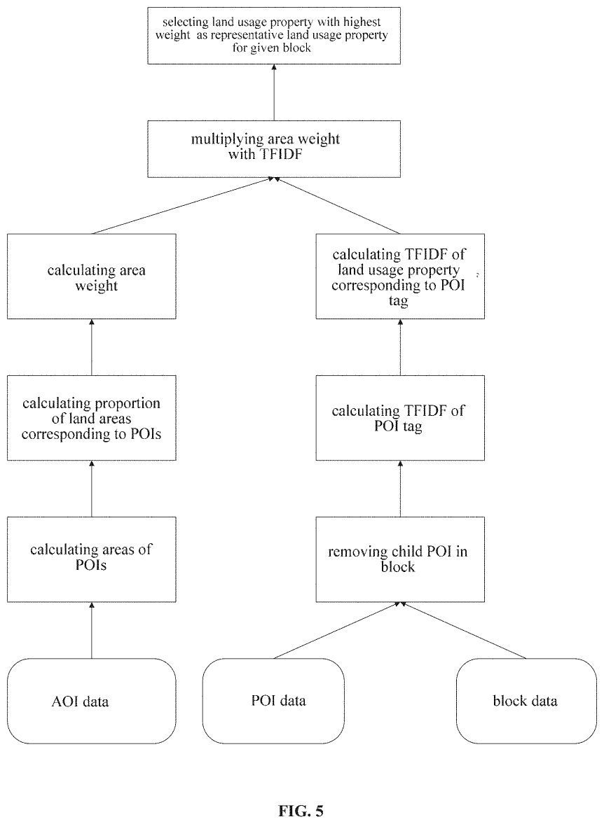

FIG. 5 is a schematic flowchart of a land usage property identification method according to an application example of an embodiment of the present application. As shown in FIG. 5, block data, AOI data and POI data (including POI with parent-child relationship) are acquired. For the POI data, after removing child POI in the block, TFIDF of the POI tag is calculated, and then TFIDF of the land usage property corresponding to the POI tag is calculated according to the TFIDF of the POI tag (that is, the second weight set in the foregoing embodiment of the present application). For the AOI data, areas of POIs contained in the AOI data are calculated, and an area weight corresponding to the AOI data is obtained after calculating a proportion of land areas corresponding to the POIs. After performing weighting operation on the TFIDF of the POI tag and the area weight corresponding to the AOI data (for example, multiplying the two weights), the land usage property with the highest weight (i.e., the target weight in the foregoing embodiment of the present application) is selected from weight values (i.e., the land usage property weight set in the foregoing embodiment of the present application) obtained by the weighting operation, and is taken as the representative land usage property for the given block. Then the process of identifying land usage property is ended.

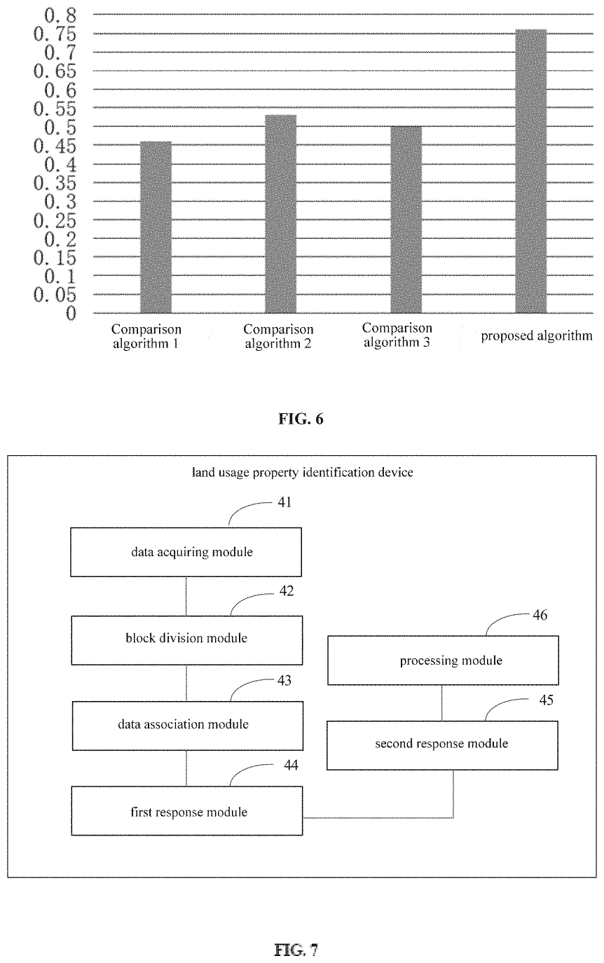

After obtaining the land usage property of the target block through the land usage property identification method of the present application, identification accuracy may be further evaluated. FIG. 6 is a schematic diagram showing comparison of identification accuracy rates according to an application example of an embodiment of the present application. FIG. 6 shows following contents.

First, Manual Labeling

A total of 300 blocks are sampled from 3% of the blocks in Beijing, and land usage properties are artificially labeled. The identification accuracy of the land identification algorithm is evaluated according to the labeling result.

Second, Comparison Algorithm

In order to evaluate the land usage identification method of the present application, the following multiple benchmark methods can be used for comparison.

a) Comparison algorithm 1: using map retrieval data to count the number of POI searches, then taking it as a weight of a corresponding land usage property, and taking the land usage property with the highest weight as land usage property for a given block.

b) Comparison algorithm 2: taking the TF-IDF of the POI tag as a weight of a corresponding land usage property in a given block.

c) Comparison algorithm 3: combining benchmark method 1 and benchmark method 2, that is, normalizing the retrieval times of POI as a search weight, then calculating the TF-IDF value of the POI tag, and finally multiplying the two as the weight of the POI tag; by looking up the land usage property mapping table, taking the calculated weight as the weight of the corresponding land usage property.

The comparison and analysis of the identification results obtained by the foregoing comparison algorithms are as follows.

The identification accuracy of each algorithm is calculated. It is found that the proposed algorithm has the highest identification accuracy, reaching 76%. FIG. 6 shows the accuracy of each identification algorithm. It can be seen from FIG. 6 that the identification accuracy of the land usage property identification method of the present application is apparently better than the first three algorithms. The reason is that the land usage property identification method of the present application uses the POI area as the main identification feature, and the land usage property of a block mainly depend on the largest POI, and thus the identification effect is good. Algorithm 3 combines the search times of POI with TF-IDF, but the effect is worse than that of TF-IDF alone. It shows that the search times of POI cannot improve the identification accuracy in determining the land usage property of a block.

After obtaining the land usage property of the target block through the land usage property identification method of the present application, an identification effect picture (not shown) may be further displayed. For example, by taking Beijing as the target area, a fine-grained land usage property identification result may be displayed in an identification effect picture, in which different colors represent different land usage properties. Generally speaking, in the center of Beijing, residential land is still the most, and other land usage properties are scattered. After clicking on a certain area in Beijing (such as Dongcheng District), composition and proportion of various land usage properties in this block may be displayed in the form of a pie chart.

By using this application example, a block-level fine-grained land usage distribution can be identified by fusing POI information, road network information and AOI data, which not only has high identification accuracy, but also timely reflects changes in urban land usage.

According to one embodiment of the present application, a land usage property identification apparatus is provided. FIG. 7 is a schematic diagram showing structures of a land usage property identification apparatus according to an embodiment of the present application. As shown in FIG. 7, the apparatus includes: a data acquiring module 41 configured for acquiring POI data and AOI data: a block division module 42 configured for dividing a target area to be identified according to road network information, and obtaining at least one block in the target area: a data association module 43 configured for associating the acquired POI data to a corresponding target block in the at least one block; a first response module 44 configured for, in response to weight processing of the POI data, obtaining a first weight set corresponding to a corresponding category of each POI data in the target block: a second response module 45 configured for, in response to weight processing of the AOI data, obtaining a second weight set corresponding to a corresponding area of each AOI data in the target block; a processing module 46 configured for obtaining a land usage property weight set according to the first weight set, the second weight set and a preset land usage classification standard; an identification module 47 configured for identifying a land usage property of the target block according to a target weight in the land usage property weight set, wherein a weight value of the target weight is greater than all other weights in the land usage property weight set.

In one embodiment, the device further includes a data deletion module configured for acquiring POI data with parent-child relationship in the target block, and deleting child POI data in the POI data with parent-child relationship.

In one embodiment, the data association module is configured for acquiring POI coordinates corresponding to the POI data, and associating the POI data with the target block based on the POI coordinates, thereby classifying the POI data to the target block.

In one embodiment, the first response module includes: a first acquiring sub-module, configured for taking all acquired POI data as a first data set; a second acquiring sub-module configured for acquiring a category of the target POI for each target POI in the first data set, wherein all categories of POIs appearing in all the POI data constitute a second data set for representing POI categories;

a statistical sub-module configured for performing statistical processing on the category of each target POI in the second data set to obtain a first frequency parameter and a second frequency parameter; a first processing sub-module configured for performing a weighting operation according to the first frequency parameter and the second frequency parameter to obtain the first weight set.

In one embodiment, the first processing sub-module is configured for counting a frequency of the category of the target POI appearing in the target block to obtain the first frequency parameter, and counting the number of blocks corresponding to the category of the target POI appearing in block-level data in each administrative level area, and obtaining the second frequency parameter according to the number of blocks.

In one embodiment, the second response module is configured for selecting a target area proportion from acquired proportions of the area corresponding to each AOI data, wherein the target area proportion is an area proportion, which is greater than all other area proportions in the target block and which represents land usage property; in a case that the target area proportion meets a proportion threshold, obtaining the second weight set according to the target area proportion.

In one embodiment, the device further includes a weight adjustment module configured for acquiring a remaining land in the target block except for the area corresponding to each AOI data; performing proportion calculation on the remaining land to obtain an area proportion of the remaining land; obtaining a remaining land property-average proportion according to the area proportion of the remaining land and the number of properties of the remaining land; and, adjusting the second weight set to obtain an adjusted second target weight set according to the remaining land property-average proportion.

Functions of each module in each device of the embodiment of the present application may refer to the corresponding description in the foregoing method, and will not be repeated here.

According to the embodiments of the present application, the present application further provides an electronic device and a readable storage medium.

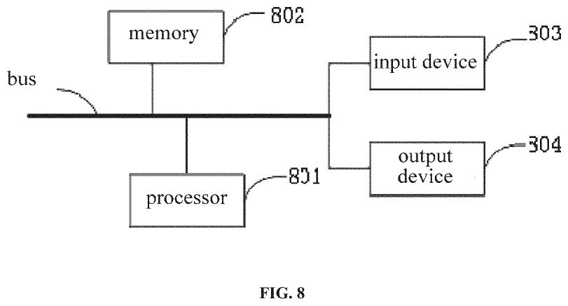

FIG. 8 is a block diagram of an electronic device used to implement a land usage property identification method according to an embodiment of the present application. The electronic device may be an aforementioned deployment device or proxy device. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processing, cellular telephones, smart phones, wearable devices, and other similar computing apparatus. The components shown herein, their connections and relationships, and their functions are by way of example only and are not intended to limit the implementations of the present application described and/or claimed herein.

As shown in FIG. 8, the electronic device includes: one or more processors 801, a memory 802, and interfaces for connecting various components, including high-speed interfaces and low-speed interfaces. The various components are interconnected using different buses and may be mounted on a common motherboard or otherwise as desired. The processor may process instructions for execution within the electronic device, including instructions stored in the memory or on the memory to display graphical information of a Graphical User Interface (GUI) on an external input/output device, such as a display device coupled to the interface. In other embodiments, multiple processors and/or multiple buses and multiple memories may be used with multiple memories if desired. Similarly, multiple electronic devices may be connected, each providing part of the necessary operations (e.g., as an array of servers, a set of blade servers, or a multiprocessor system). In FIG. 8, one processor 801 is taken as an example.

The memory 802 is a non-transitory computer-readable storage medium provided herein. The memory stores instructions executable by at least one processor to enable the at least one processor to implement the land usage property identification method provided by the present application. The non-transitory computer-readable storage medium of the present application stores computer instructions for enabling a computer to implement the land usage property identification method provided by the present application.

The memory 802, as a non-transitory computer-readable storage medium, may be used to store non-transitory software programs, non-transitory computer-executable programs, and modules, such as program instructions/modules (e.g., the data acquiring module, the block division module, the data association module, the first response module, the second response module, the processing module, identification module shown in FIG. 7) corresponding to the land usage property identification method of embodiments of the present application. The processor 801 executes various functional applications of the server and data processing, i.e., the land usage property identification method in the above-mentioned method embodiment, by operating non-transitory software programs, instructions, and modules stored in the memory 802.

The memory 802 may include a program storage area and a data storage area, wherein the program storage area may store an application program required by an operating system and at least one function: the data storage area may store data created according to the use of the electronic device. In addition, the memory 802 may include a high speed random access memory, and may also include a non-transitory memory, such as at least one magnetic disk storage device, a flash memory device, or other non-transitory solid state memory device. In some embodiments, the memory 802 may optionally include memories remotely located with respect to processor 801, which may be connected via a network to the electronic device. Examples of such networks include, but are not limited to, the Internet, intranet, local area networks, mobile communication networks, and combinations thereof.

The electronic device of the land usage property identification method may further include: an input device 803 and an output device 804. The processor 801, the memory 802, the input device 803, and the output device 804 may be connected via a bus or otherwise. FIG. 8 takes a bus connection as an example.

The input device 803 may receive input numeric or character information and generate key signal inputs related to user settings and functional controls of the electronic device, such as input devices including touch screens, keypads, mice, track pads, touch pads, pointing sticks, one or more mouse buttons, trackballs, joysticks, etc. The output device 804 may include display devices, auxiliary lighting devices (e.g., LEDs), tactile feedback devices (e.g., vibration motors), and the like. The display device may include, but is not limited to, a Liquid Crystal Display (LCD), a Light Emitting Diode (LED) display, and a plasma display. In some embodiments, the display device may be a touch screen.

Various embodiments of the systems and techniques described herein may be implemented in digital electronic circuit systems, integrated circuit systems, Application Specific Integrated Circuits (ASICs), computer hardware, firmware, software, and/or combinations thereof. These various embodiments may include: implementation in one or more computer programs which can be executed and/or interpreted on a programmable system including at least one programmable processor, and the programmable processor may be a dedicated or general-purpose programmable processor which can receive data and instructions from, and transmit data and instructions to, a memory system, at least one input device, and at least one output device.

These computing programs (also referred to as programs, software, software applications, or codes) include machine instructions of a programmable processor, and may be implemented using high-level procedural and/or object-oriented programming languages, and/or assembly/machine languages. As used herein, the terms “machine-readable medium” and “computer-readable medium” refer to any computer program product, device, and/or apparatus (e.g., magnetic disk, optical disk, memory, programmable logic device (PLD)) for providing machine instructions and/or data to a programmable processor, including a machine-readable medium that receives machine instructions as machine-readable signals. The term “machine-readable signal” refers to any signal used to provide machine instructions and/or data to a programmable processor.

To provide for interaction with a user, the systems and techniques described herein may be implemented on a computer having: a display device (e.g., a Cathode Ray Tube (CRT) or Liquid Crystal Display (LCD) monitor) for displaying information to a user; and a keyboard and a pointing device (e.g., a mouse or a trackball) by which a user can provide input to the computer. Other types of devices may also be used to provide interaction with a user; for example, the feedback provided to the user may be any form of sensory feedback (e.g., visual feedback, audile feedback, or tactile feedback); and input from the user may be received in any form, including acoustic input, audio input, or tactile input.

The systems and techniques described herein may be implemented in a computing system that includes a background component (e.g., as a data server), or a computing system that includes a middleware component (e.g., an application server), or a computing system that includes a front-end component (e.g., a user computer having a graphical user interface or a web browser through which a user may interact with embodiments of the systems and techniques described herein), or in a computing system that includes any combination of such background component, middleware component, or front-end component. The components of the system may be interconnected by digital data communication (e.g., a communication network) of any form or medium. Examples of the communication network include: Local Area Networks (LANs), Wide Area Networks (WANs), and the Internet.

The computer system may include a client and a server. The client and the server are typically remote from each other and typically interact through a communication network. A relationship between the client and the server is generated by computer programs operating on respective computers and having a client-server relationship with each other.

With the present application, the POI data and the AOI data may be acquired; the target area to be identified is divided according to the road network information, and at least one block in the target area is obtained. After the acquired POI data is associated to a corresponding target block in the at least one block, the first weight set corresponding to the corresponding category of each POI data in the target block is obtained, and the second weight set corresponding to the corresponding area of each AOI data in the target block is obtained. Then, the land usage property weight set can be obtained according to the first weight set, the second weight set and the preset land usage classification standard. And then, the land usage property of the target block can be identified according to the target weight with its weight value being greater than all other weights in the land usage property weight set, thereby improving accuracy of land usage property identification.

It will be appreciated that the various forms of flow, reordering, adding or removing steps shown above may be used. For example, the steps recited in the present application may be performed in parallel or sequentially or may be performed in a different order, so long as the desired results of the technical solutions disclosed in the present application can be achieved, and no limitation is made herein.

The above-mentioned embodiments are not to be construed as limiting the scope of the present application. It will be apparent to those skilled in the art that various modifications, combinations, sub-combinations and substitutions are possible, depending on design requirements and other factors. Any modifications, equivalents, and improvements within the spirit and principles of the present application are intended to be included within the scope of the present application.

What is claimed is:

1. A land usage property identification method, comprising:
acquiring point-of-interest (POI) data and area-of-interest (AOI) data;
dividing a target area to be identified according to road network information, and obtaining at least one block in the target area;
associating acquired POI data to a corresponding target block in the at least one block;
in response to weight processing of the POI data, obtaining a first weight set corresponding to a corresponding category of each POI data in the target block;
in response to weight processing of the AOI data, obtaining a second weight set corresponding to a corresponding area of each AOI data in the target block;
obtaining a land usage property weight set according to the first weight set, the second weight set and a preset land usage classification standard; and
identifying a land usage property of the target block according to a target weight in the land usage property weight set, wherein a weight value of the target weight is greater than all other weights in the land usage property weight set.

2. The method according to claim 1, further comprising:
acquiring POI data with parent-child relationship in the target block; and
deleting child POI data in the POI data with parent-child relationship.

3. The method according to claim 1, wherein the associating acquired POI data to the corresponding target block in the at least one block, comprises:
acquiring POI coordinates corresponding to the POI data; and
associating the POI data with the target block based on the POI coordinates, thereby classifying the POI data to the target block.

4. The method according to claim 1, wherein in response to weight processing of the POI data, obtaining the first weight set corresponding to the corresponding category of each POI data in the target block, comprises:
taking all acquired POI data as a first data set;
for each target POI in the first data set, acquiring a category of the target POI, wherein all categories of POIs appearing in all the POI data constitute a second data set for representing POI categories;
performing statistical processing on the category of each target POI in the second data set to obtain a first frequency parameter and a second frequency parameter; and
performing a weighting operation according to the first frequency parameter and the second frequency parameter to obtain the first weight set.

5. The method according to claim 4, wherein the performing statistical processing on the category of each target POI in the second data set to obtain the first frequency parameter and the second frequency parameter, comprises:
counting a frequency of the category of the target POI appearing in the target block to obtain the first frequency parameter; and
counting the number of blocks corresponding to the category of the target POI appearing in block-level data in each administrative level area and obtaining the second frequency parameter according to the number of blocks.

6. The method according to claim 1, wherein in response to weight processing of the AOI data, obtaining the second weight set corresponding to the corresponding area of each AOI data in the target block, comprises:
selecting a target area proportion from acquired proportions of the area corresponding to each AOI data, wherein the target area proportion is an area proportion greater than all other area proportions in the target block and representing land usage property; and
in response that the target area proportion meets a proportion threshold, obtaining the second weight set according to the target area proportion.

7. The method according to claim 6, further comprising:
acquiring a remaining land in the target block except for the area corresponding to each AOI data;
performing proportion calculation on the remaining land to obtain an area proportion of the remaining land;
according to the area proportion of the remaining land and the number of properties of the remaining land, obtaining a remaining land property-average proportion; and
according to the remaining land property-average proportion, adjusting the second weight set to obtain an adjusted second target weight set.

8. A land usage property identification apparatus, comprising:
a processor and a memory for storing one or more computer programs executable by the processor,
wherein when executing at least one of the computer programs, the processor is configured to perform operations comprising:
acquiring point-of-interest (POI) data and area-of-interest (AOI) data;
dividing a target area to be identified according to road network information, and obtaining at least one block in the target area;
associating the acquired POI data to a corresponding target block in the at least one block;
in response to weight processing of the POI data, obtaining a first weight set corresponding to a corresponding category of each POI data in the target block;
in response to weight processing of the AOI data, obtaining a second weight set corresponding to a corresponding area of each AOI data in the target block;
obtaining a land usage property weight set according to the first weight set, the second weight set and a preset land usage classification standard; and
identifying a land usage property of the target block according to a target weight in the land usage property weight set, wherein a weight value of the target weight is greater than all other weights in the land usage property weight set.

9. The apparatus according to claim 8, wherein when executing at least one of the computer programs, the processor is further configured to perform operations comprising:
acquiring POI data with parent-child relationship in the target block; and
deleting child POI data in the POI data with parent-child relationship to obtain to-be-processed POI data.

10. The apparatus according to claim 8, wherein when executing at least one of the computer programs, the processor is further configured to perform operations comprising:
acquiring POI coordinates corresponding to the POI data; and
associating the POI data with the target block based on the POI coordinates, thereby classifying the POI data to the target block.

11. The apparatus according to claim 8, wherein when executing at least one of the computer programs, the processor is further configured to perform operations comprising:
taking all acquired POI data as a first data set;
acquiring a category of the target POI for each target POI in the first data set, wherein all categories of POIs appearing in all the POI data constitute a second data set for representing POI categories;
performing statistical processing on the category of each target POI in the second data set to obtain a first frequency parameter and a second frequency parameter; and
performing a weighting operation according to the first frequency parameter and the second frequency parameter to obtain the first weight set.

12. The apparatus according to claim 11, wherein when executing at least one of the computer programs, the processor is further configured to perform operations comprising:
counting a frequency of the category of the target POI appearing in the target block to obtain the first frequency parameter; and
counting the number of blocks corresponding to the category of the target POI appearing in block-level data in each administrative level area, and obtaining the second frequency parameter according to the number of blocks.

13. The apparatus according to claim 8, wherein when executing at least one of the computer programs, the processor is further configured to perform operations comprising:
selecting a target area proportion from acquired proportions of the area corresponding to each AOI data, wherein the target area proportion is an area proportion greater than all other area proportions in the target block and representing land usage property; and
in response that the target area proportion meets a proportion threshold, obtaining the second weight set according to the target area proportion.

14. The apparatus according to claim 13, wherein when executing at least one of the computer programs, the processor is further configured to perform operations comprising:
acquiring a remaining land in the target block except for the area corresponding to each AOI data;
performing proportion calculation on the remaining land to obtain an area proportion of the remaining land;
obtaining a remaining land property-average proportion according to the area proportion of the remaining land and the number of properties of the remaining land; and
adjusting the second weight set according to the remaining land property-average proportion, to obtain an adjusted second target weight set.

15. A non-transitory computer-readable storage medium, storing computer instructions for causing a computer to perform the method of claim 1.

16. A non-transitory computer-readable storage medium, storing computer instructions for causing a computer to perform the method of claim 2.

17. A non-transitory computer-readable storage medium, storing computer instructions for causing a computer to perform the method of claim 3.

18. A non-transitory computer-readable storage medium, storing computer instructions for causing a computer to perform the method of claim 4.

19. A non-transitory computer-readable storage medium, storing computer instructions for causing a computer to perform the method of claim 5.

20. A non-transitory computer-readable storage medium, storing computer instructions for causing a computer to perform the method of claim 6.
